(19) United States
(12) Patent Application Publication
(10) Pub. No.: US 2020/0248663 A1
(43) Pub. Date: Aug. 6, 2020

(54) HIGH-PRESSURE FUEL PUMP

(71) Applicant: Hitachi Automotive Systems, Ltd., Hitachinaka-shi, Ibaraki (JP)

(72) Inventors: Kenichiro TOKUO, Hitachinaka (JP); Satoshi USUI, Hitachinaka (JP); Ryo KUSAKABE, Tokyo (JP)

(73) Assignee: Hitachi Automotive Systems, Ltd., Hitachinaka-shi, Ibaraki (JP)

(21) Appl. No.: 16/756,160

(22) PCT Filed: Oct. 29, 2018
(86) PCT No.: PCT/JP2018/040035

§ 371 Date: Apr. 15, 2020

(30) Foreign Application Priority Data
Nov. 16, 2017 (JP) 2017-220781

(51) Int. Cl. F02M 59/44

(52) U.S. Cl. CPC F02M 59/445

(57) ABSTRACT

To provide a high-pressure fuel pump capable of ensuring good magnetic properties and reliability for cracking. Therefore, the fixed core 39 is precipitation hardening type ferritic stainless steel (ferritic precipitation hardening type metal). The anchor 36 is precipitation hardening type ferritic stainless steel attracted by the magnetic attraction force of the fixed core 39. The outer core 38 has an inner peripheral surface on which the outer peripheral surface of the anchor 36 slides. The seal ring 48 is formed of a material having hardness lower than that of the fixed core 39 and the anchor 36, and connects the fixed core 39 and the outer core 38.

### TECHNICAL FIELD

The present invention relates to a high-pressure fuel pump.

### BACKGROUND ART

There is a conventional technique of the high-pressure fuel pump of the present invention as described in PTL 1. PTL 1 discloses in paragraph 0058 that “the anchor and the second core are made of magnetic stainless steel to form a magnetic circuit, and the impingement surface of each of the anchor and the second core is subjected to surface treatment for improving hardness.” and “surface treatment includes hard Cr plating”.

As a conventional technique for a magnetic material product, although not a high-pressure fuel pump, PTL 2 discloses in paragraph 0035 that “the fixed core, the movable core, and the magnetic cylinder are all made of a ferritic high-hardness magnetic material”. Furthermore, PTL 2 discloses in paragraph 0004 that “the ferritic high-hardness magnetic material is subjected to precipitation hardening, thermal hardening, and thermal treatment”.

### CITATION LIST

### Patent Literature

PTL 1: JP 2016-94913 A

PTL 2: JP 2004-300540 A

### SUMMARY OF INVENTION

### Technical Problem

However, in the structure of PTL 1, the hard plating treatment is applied to the impingement surface, and hence the number of components and the number of steps increase, thereby increasing the cost. When the ferritic high-hardness magnetic material described in PTL 2 is applied, there is a possibility that plating treatment can be omitted because of its high hardness and wear resistance, but on the other hand, precipitation hardening type stainless steel generally has low toughness, thereby requiring treatment for cracking.

An object of the present invention is to provide a high-pressure fuel pump capable of ensuring good magnetic properties and reliability for cracking.

### Solution to Problem

In order to achieve the above object, the present invention is directed to: a ferritic precipitation hardening type metal fixed core; a ferritic precipitation hardening type metal anchor attracted by a magnetic attraction force of the fixed core; an outer core having an inner peripheral surface on which an outer peripheral surface of the anchor slides; and a seal ring formed of a material having hardness lower than hardness of the fixed core and the anchor, the seal ring connecting the fixed core and the outer core.

### Advantageous Effects of Invention

According to the present invention, it is possible to ensure good magnetic properties and reliability for cracking. Problems, configurations, and effects other than those described above will be made clear from the following description of embodiments.

### BRIEF DESCRIPTION OF DRAWINGS

FIG. 1 illustrates a configuration diagram of an engine system to which a high-pressure fuel pump of the present embodiment is applied.

FIG. 2 is a longitudinal cross-sectional view of the high-pressure fuel pump of the present embodiment.

FIG. 3 is a horizontal cross-sectional view of the high-pressure fuel pump of the present embodiment as viewed from above.

FIG. 4 is a longitudinal cross-sectional view of the high-pressure fuel pump of the present embodiment as viewed from a different direction from FIG. 2.

FIG. 5 is an enlarged longitudinal cross-sectional view of an electromagnetic valve mechanism of the high-pressure fuel pump of the present embodiment, illustrating a state in which the electromagnetic valve mechanism is in a valve opening state.

FIG. 6 illustrates an enlarged longitudinal cross-sectional view of an electromagnetic valve mechanism of a high-pressure fuel pump of another embodiment.

### DESCRIPTION OF EMBODIMENTS

Hereinafter, a high-pressure fuel supply pump (hereinafter referred to as high-pressure fuel pump) according to an embodiment of the present invention will be described in detail with reference to the drawings. Although partially overlapping with the object of the invention described above, an object of the present embodiment is to provide an electromagnetic valve which achieves both reliability and manufacturing cost without deteriorating magnetic properties, and a high-pressure fuel pump equipped with the electromagnetic valve.

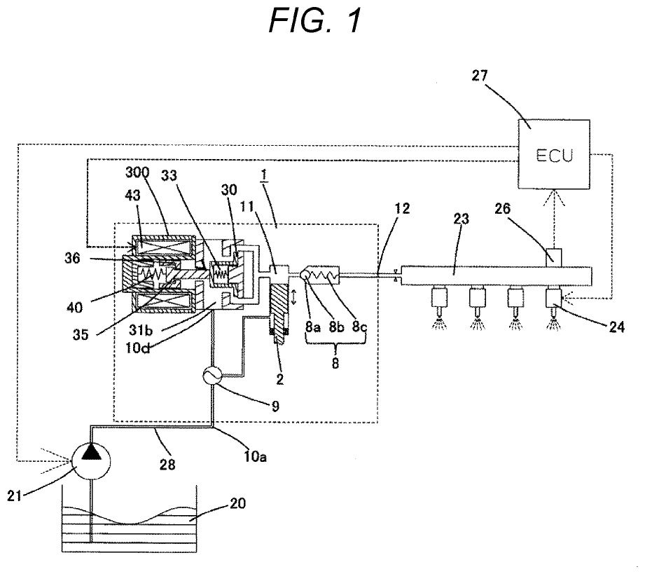

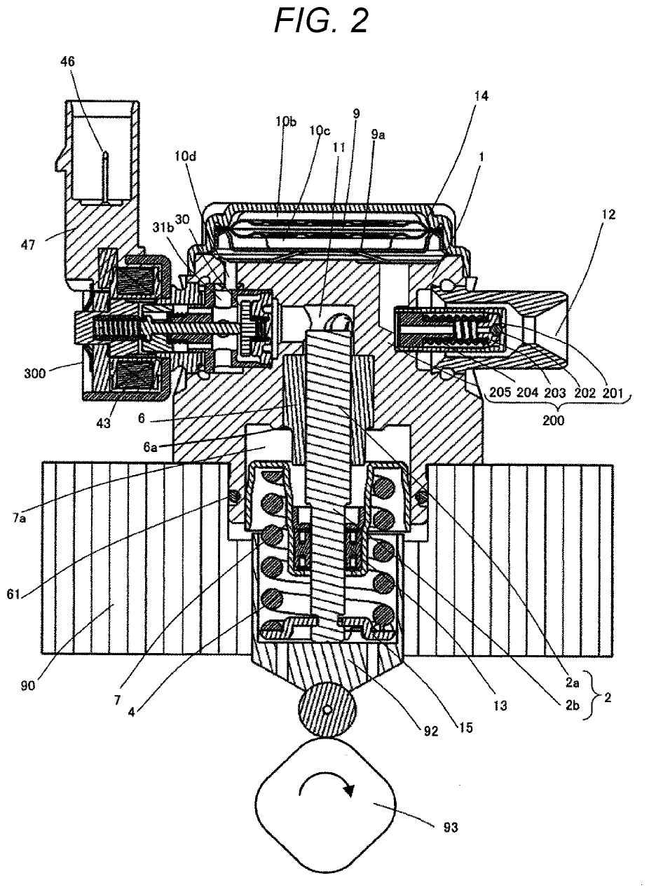

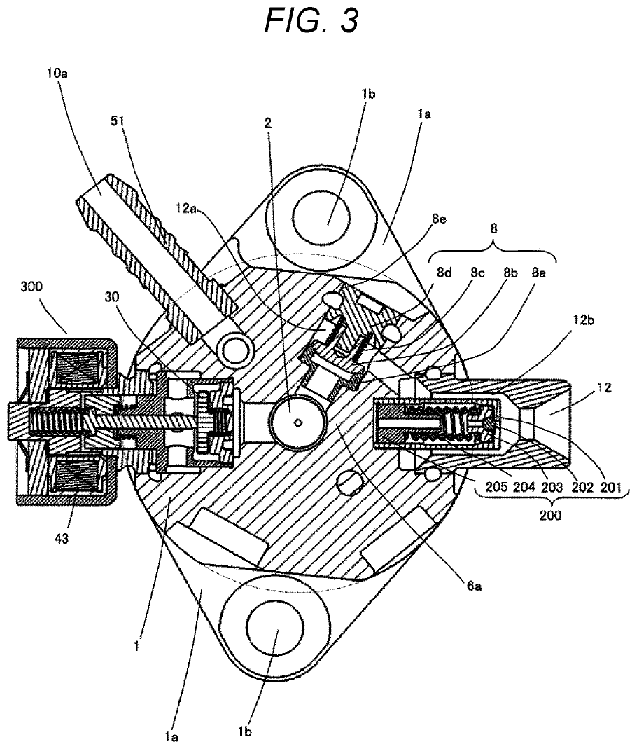

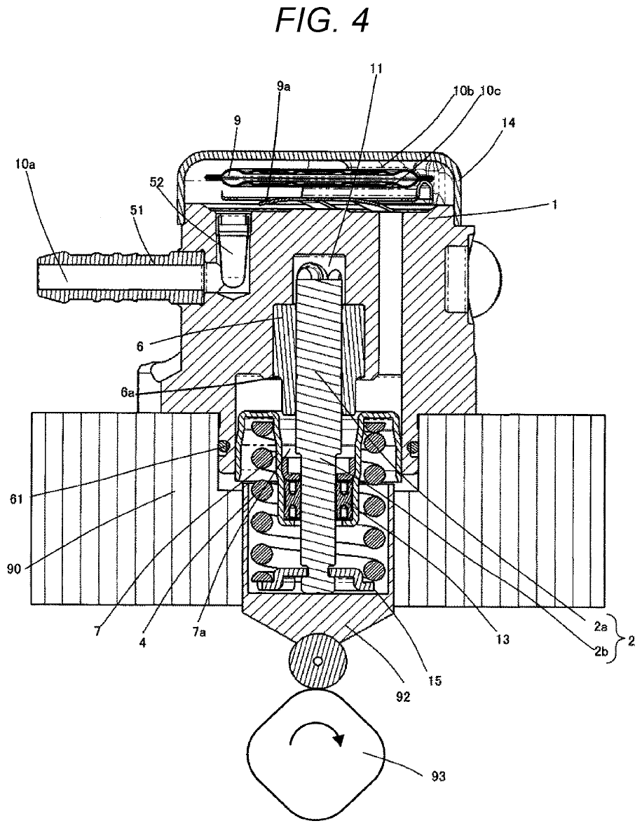

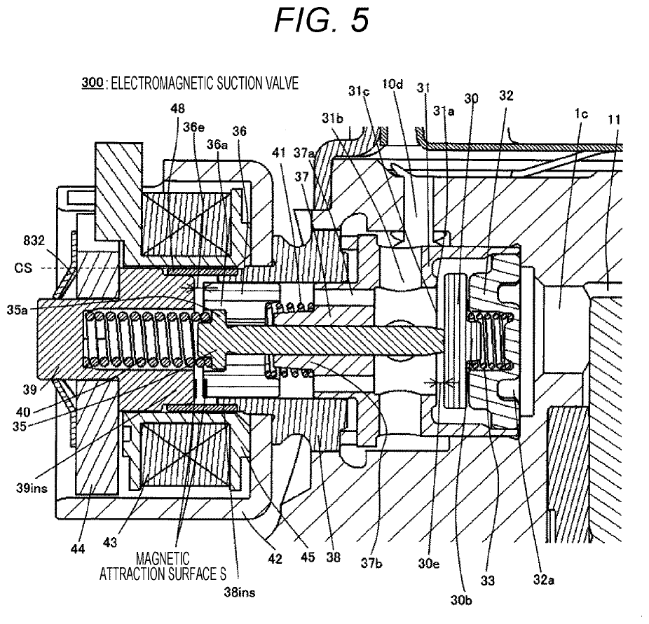

FIG. 1 illustrates an overall configuration diagram of an engine system. The portion surrounded by a broken line indicates a main body of the high-pressure fuel pump, indicating that the mechanism and components illustrated in the broken line are integrally incorporated into a pump body 1. FIG. 1 is a diagram schematically illustrating the operation of the engine system, and some of the detailed configuration is different from the configuration of the high-pressure fuel pump in FIG. 2 and subsequent figures. FIG. 2 is a longitudinal cross-sectional view of the high-pressure fuel pump of the present embodiment, and FIG. 3 is a horizontal cross-sectional view of the high-pressure fuel pump as viewed from above. FIG. 4 is a longitudinal cross-sectional view of the high-pressure fuel pump viewed from a different direction from FIG. 2. FIG. 5 is an enlarged view of an electromagnetic valve mechanism 300 (electromagnetic suction valve).

Fuel in a fuel tank 20 is pumped up by a feed pump 21 on the basis of a signal from an engine control unit 27 (hereinafter referred to as ECU). This fuel is pressurized to an appropriate feed pressure and sent to a low-pressure fuel suction port 10a of the high-pressure fuel pump through a suction pipe 28.

The fuel having passed through a suction joint 51 (FIG. 3) from the low-pressure fuel suction port 10a reaches a suction port 31b of the electromagnetic valve mechanism 300 constituting a variable capacity mechanism via damper chambers (10b and 10c) in which a pressure pulsation reduction mechanism is arranged. Specifically, the electromagnetic valve mechanism 300 constitutes an electromagnetic suction valve mechanism.

The fuel having flown into the electromagnetic valve mechanism 300 passes through a suction port opened and closed by a suction valve 30 and flows into a pressurizing chamber 11. Power for reciprocating motion is given to a plunger 2 by a cam 93 (cam mechanism) of the engine. By reciprocating motion of the plunger 2, the fuel is sucked from the suction valve 30 in a downward stroke of the plunger 2, and the fuel is pressurized in an upward stroke. The pressurized fuel is pressure-fed via a discharge valve mechanism 8 to a common rail 23 on which a pressure sensor 26 is mounted.

Then, an injector 24 injects fuel to the engine on the basis of a signal from the ECU 27.

The present embodiment is directed to a high-pressure fuel pump applied to a so-called direct injection engine system in which the injector 24 injects fuel directly into a cylinder of the engine. The high-pressure fuel pump discharges a fuel flow rate of a desired fuel supply by a signal from the ECU 27 to the electromagnetic valve mechanism 300.

As illustrated in FIGS. 2 and 3, the high-pressure fuel pump of the present embodiment is fixed in close contact with a high-pressure fuel pump mounting portion 90 of an internal combustion engine. Specifically, as illustrated in FIG. 3, a screw hole 1b is formed in a mounting flange 1a provided in the pump body 1, and a plurality of bolts that are not illustrated are inserted into the screw hole 1b. In this manner, the mounting flange 1a comes into close contact with and is fixed to the high-pressure fuel pump mounting portion 90 of the internal combustion engine. An O-ring 61 is fitted into the pump body 1 for sealing between the high-pressure fuel pump mounting portion 90 and the pump body 1, thereby preventing engine oil from leaking to the outside.

As illustrated in FIGS. 2 and 4, the pump body 1 is attached with a cylinder 6 that guides the reciprocating motion of the plunger 2 and forms the pressurizing chamber 11 together with the pump body 1. That is, the plunger 2 changes the volume of the pressurizing chamber by reciprocating motion inside the cylinder. The electromagnetic valve mechanism 300 for supplying fuel to the pressurizing chamber 11 and the discharge valve mechanism 8 for discharging fuel from the pressurizing chamber 11 to a discharge passage are provided.

The cylinder 6 is press-fitted into the pump body 1 on its outer peripheral side. An insertion hole for inserting the cylinder 6 from below is formed in the pump body 1, and an inner peripheral protrusion portion deformed to the inner peripheral side so as to come into contact with the lower surface of a fixed portion 6a of the cylinder 6 at the lower end of the insertion hole is formed. The upper surface of the inner peripheral protrusion portion of the pump body 1 presses the fixed portion 6a of the cylinder 6 upward in the figure, and seals the upper end surface of the cylinder 6 so that the fuel pressurized in the pressurizing chamber 11 does not leak to the low pressure side.

The lower end of the plunger 2 is provided with a tappet 92 that converts the rotational motion of the cam 93 attached to a camshaft of the internal combustion engine into a vertical motion and transmits the vertical motion to the plunger 2. The plunger 2 is crimped to the tappet 92 by a spring 4 via a retainer 15. This allows the plunger 2 to vertically reciprocate with the rotational motion of the cam 93.

Furthermore, a plunger seal 13 held at the inner peripheral lower end portion of a seal holder 7 is installed in a state of coming into slidable contact with the outer periphery of the plunger 2 at the lower portion of the cylinder 6 in the figure. Thus, when the plunger 2 slides, the fuel in an auxiliary chamber 7a is sealed to prevent the fuel from flowing into the internal combustion engine. At the same time, lubricating oil (including engine oil) that lubricates a sliding portion in the internal combustion engine is prevented from flowing into the inside of the pump body 1.

As illustrated in FIGS. 3 and 4, the suction joint 51 is attached to a side surface portion of the pump body 1 of the high-pressure fuel pump. The suction joint 51 is connected to a low-pressure pipe through which fuel from the fuel tank 20 of the vehicle is supplied, and the fuel is supplied to the inside of the high-pressure fuel pump from the suction joint 51. A suction filter 52 has a role of preventing a foreign matter existing between the fuel tank 20 and the low-pressure fuel suction port 10a from being absorbed into the high-pressure fuel pump by the flow of fuel.

The fuel having passed through the low-pressure fuel suction port 10a is directed to the pressure pulsation reduction mechanism 9 through a low-pressure fuel suction passage vertically communicating with the pump body 1 illustrated in FIG. 4. The pressure pulsation reduction mechanism 9 is arranged in the damper chambers (10b and 10c) between a damper cover 14 and the upper end surface of the pump body 1, and is supported from below by a holding member 9a arranged on the upper end surface of the pump body 1. Specifically, the pressure pulsation reduction mechanism 9 is a metal damper configured by stacking two metal diaphragms. A gas of 0.3 MPa to 0.6 MPa is sealed inside the pressure pulsation reduction mechanism 9, and the outer peripheral edge portion is fixed by welding. For this purpose, the pressure pulsation reduction mechanism 9 is configured to have a thin outer peripheral edge portion that becomes thicker toward the inner peripheral side.

Then, as illustrated in FIG. 2, a protrusion portion for fixing the outer peripheral edge portion of the pressure pulsation reduction mechanism 9 from below is formed on the upper surface of the holding member 9a. On the other hand, a protrusion portion for fixing the outer peripheral edge portion of the pressure pulsation reduction mechanism 9 from above is formed on the lower surface of the damper cover 14. These protrusion portions are formed in a circular shape, and the pressure pulsation reduction mechanism 9 is fixed by being sandwiched by these protrusion portions. The damper cover 14 is press-fitted into and fixed to the outer edge portion of the pump body 1, and at this time, the holding member 9a is elastically deformed to support the pressure pulsation reduction mechanism 9.

In this manner, the damper chambers (10b and 10c) communicating with the low-pressure fuel suction port 10a and the low-pressure fuel suction passage are formed on the upper and lower surfaces of the pressure pulsation reduction mechanism 9. Although not illustrated in the drawings, a passage through which the upper side and the lower side of the pressure pulsation reduction mechanism 9 communicate with each other is formed in the holding member 9a, whereby the damper chambers (10b and 10c) are formed on the upper and lower surfaces of the pressure pulsation reduction mechanism 9.

The fuel having passed through the damper chambers (10b and 10c) then reaches the suction port 31b of the electromagnetic valve mechanism 300 via a suction passage 10d (low-pressure fuel suction passage) formed in vertical communication with the pump body. The suction port 31b is formed in vertical communication with a suction valve seat member 31 forming a suction valve seat 31a.

The electromagnetic valve mechanism 300 (electromagnetic suction valve) will be described in detail with reference to FIG. 5. There is a coil 43 (electromagnetic coil) in which a copper wire is wound to a bobbin 45 a plurality of times, and both ends of the copper wire of the coil are connected energizably to respective ends of two terminals 46 (illustrated in FIG. 2). The terminal 46 is molded integrally with a connector 47 (illustrated in FIG. 2), and the other end can be connected with the engine control unit side.

The components surrounding the outer periphery of the coil 43 include a first yoke 42, a second yoke 44, and an outer core 38. The first yoke 42 and the second yoke 44 are arranged so as to surround the coil 43, and molded integrally with and fixed to a connector that is a resin member. The outer core 38 is press-fitted into and fixed to a hole portion in a center portion of the first yoke 42. The outer core 38 is fixed to the pump body 1 by welding or the like.

The inner diameter side of the second yoke 44 is configured to be in contact with a fixed core 39 or close to the fixed core 39 with a slight clearance. The outer diameter side of the second yoke 44 is configured to be in contact with the inner periphery of the first yoke 42 or close to the inner periphery of the first yoke 42 with a slight clearance. A fixing pin 832 is fixed to the fixed core 39, and a biasing force is generated so as to press the second yoke 44 against the fixed core 39. The fixing pin 832 may bite into the fixed core 39 at a corner portion on the inner peripheral side, or may be fixed by welding or the like.

Both the first yoke 42 and the second yoke 44 are made of a magnetic stainless material in order to constitute a magnetic circuit and in consideration of corrosion resistance. A high-strength heat-resistant resin is used for the bobbin 45 and the connector 47 in consideration of strength properties and heat resistance properties.

A seal ring 48 is welded and fixed to the outer core 38 on the inner periphery of the coil 43, and is welded and fixed to the fixed core 39 at the opposite end thereof. On the inner periphery of the seal ring 48 or the outer core 38, there are an anchor 36 (mover) and a rod 35 which are movable portions, a rod guide 37 which is a fixed portion, a rod biasing spring 40, and an anchor biasing spring 41. The rod 35 is axially slidably held on the inner peripheral side of the rod guide 37 and slidably holds the anchor 36.

When a current flows through the coil 43, the anchor 36 is attracted toward the fixed core 39 by the generated magnetic attraction force. In order to axially move freely and smoothly in the fuel, the anchor 36 has one or more through-holes 36a penetrating in a component axial direction, thereby eliminating as much as possible the restriction of motion due to a pressure difference between the front and rear of the anchor.

The rod guide 37 is radially inserted into an inner peripheral side of a hole into which the suction valve of the pump body 1 is inserted, and the rod guide 37 axially abuts against one end portion of the suction valve seat. The rod guide 37 is configured to be arranged so as to be sandwiched between the outer core 38 welded and fixed to an insertion hole of the pump body 1 and the pump body 1. Similarly to the anchor 36, the rod guide 37 is also provided with an axially penetrating through-hole 37a, thereby configuring so as not to obstruct the movement of the internal fuel when the anchor moves axially.

The outer core 38 is fixed to the pump body 1 by welding or the like, the seal ring 48 is fixed to the other end welded to the pump body 1 as described above, and the fixed core 39 is further fixed to the other end. The rod biasing spring 40 is arranged on the inner peripheral side of the fixed core 39 with the small diameter portion of the rod 35 arranged to the guide, and biases the rod 35 rightward in the figure. The rod 35 engages with the anchor 36 via a flange portion 35a. At the same time, the rod 35 engages with the suction valve 30 at the distal end, and applies a biasing force in a direction in which the suction valve 30 is separated from the suction valve seat 31a, that is, a valve opening direction of the suction valve.

The anchor biasing spring 41 is arranged to apply a biasing force to the anchor 36 in the flange portion 35a direction (leftward in the figure) while keeping the anchor coaxial by inserting its one end into a cylindrical center bearing portion 37b provided on the center side of the rod guide 37. A movement amount 36e of the anchor 36 is set greater than a movement amount 30e of the suction valve 30, thereby preventing the suction valve 30 from interfering at the time of closing the valve.

The outer core 38, the first yoke 42, the second yoke 44, the fixed core 39, and the anchor 36 form a magnetic circuit around the coil 43, and when a current is applied to the coil 43, a magnetic attraction force is generated between the fixed core 39 and the anchor 36. Since the anchor 36 and the fixed core 39 form a magnetic attraction surface, it is desirable to use a material having good magnetic properties in terms of performance. At the same time, it needs hardness enough to withstand the impingement. Precipitation hardening type ferritic stainless steel is used as a material satisfying them.

The seal ring 48 is desirably a non-magnetic material in order to allow magnetic flux to flow between the anchor 36 and the fixed core 39. In addition, in order to absorb the impact at the time of impingement, it is desirable to use a thin stainless material having a large elongation. Specifically, austenitic stainless steel is used.

As illustrated in FIG. 3, the discharge valve mechanism 8 provided at the outlet of the pressurizing chamber 11 is constituted by a discharge valve seat 8a, a discharge valve 8b being in contact with and separated from the discharge valve seat 8a, a discharge valve spring 8c biasing the discharge valve 8b toward the discharge valve seat 8a, and a discharge valve stopper 8d determining the stroke (movement distance) of the discharge valve 8b. The discharge valve stopper 8d and the pump body 1 are joined by welding at an abutting portion 8e, thereby cutting off the fuel from the outside.

When there is no fuel differential pressure between the pressurizing chamber 11 and a discharge valve chamber 12a, the discharge valve 8b is crimped to the discharge valve seat 8a by the biasing force of the discharge valve spring 8c, and is in a valve closing state. It is not until the fuel pressure in the pressurizing chamber 11 becomes higher than the fuel pressure in the discharge valve chamber 12a that the discharge valve 8b opens against the discharge valve spring 8c. Then, the high-pressure fuel in the pressurizing chamber 11 is discharged to the common rail 23 through the discharge valve chamber 12a, a fuel discharge passage 12b, and a fuel discharge port 12.

When opening, the discharge valve 8b comes into contact with the discharge valve stopper 8d, thereby restricting the stroke. Accordingly, the stroke of the discharge valve 8b is appropriately determined by the discharge valve stopper 8d. This can prevent the fuel having been discharged to the discharge valve chamber 12a at high pressure from flowing back into the pressurizing chamber 11 again due to the delay in closing the discharge valve 8b caused by a stroke that is too large, and can suppress the efficiency of the high-pressure fuel pump from decreasing. The discharge valve 8b is guided at the outer peripheral surface of the discharge valve stopper 8d so as to move only in a stroke direction when the discharge valve 8b repeats valve opening and valve closing motions. As described above, the discharge valve mechanism 8 serves as a check valve that restricts a distribution direction of the fuel.

A relief valve mechanism 200 illustrated in FIG. 3 includes a relief body 201, a relief valve 202, a relief valve holder 203, a relief spring 204, and a spring stopper 205. The relief body 201 is provided with a seat portion. The relief valve 202 is loaded by the load of the relief spring 204 via the relief valve holder 203, pressed to the seat portion of the relief body 201, and cuts off the fuel in cooperation with the seat portion. The valve opening pressure of the relief valve 202 is determined by the load of the relief spring 204. The spring stopper 205 is press-fitted into and fixed to the relief body 201, and the load of the relief spring 204 is adjusted in accordance with the position of the press-fitting and fixing.

When the pressure at the fuel discharge port 12 becomes abnormally high due to failure of the electromagnetic valve mechanism 300 of the high-pressure fuel pump or the like, and becomes greater than the set pressure of the relief valve mechanism 200, the abnormally high-pressure fuel is relieved to the pressurizing chamber 11 via a relief passage.

As described above, the pressurizing chamber 11 is constituted by the pump body 1, the electromagnetic valve mechanism 300, the plunger 2, the cylinder 6, and the discharge valve mechanism 8.

A detailed operation of the electromagnetic valve mechanism 300 will be described with reference to FIG. 5. When the plunger 2 moves in the direction of the cam 93 by rotation of the cam 93 and is in a suction stroke state, the volume of the pressurizing chamber 11 increases and the fuel pressure in the pressurizing chamber 11 decreases. When the fuel pressure in the pressurizing chamber 11 becomes lower than the pressure at the suction port 31b in this stroke, the suction valve 30 becomes in a valve opening state. 30e denotes a maximum opening, and at this time, the suction valve 30 comes into contact with a stopper 32. By opening of the suction valve 30, an opening portion 31c formed in the suction valve seat member 31 opens. The fuel passes through the opening portion 31c and flows into the pressurizing chamber 11 via a hole 1c formed in the pump body 1 in a lateral direction. The hole 1c also constitutes part of the pressurizing chamber 11.

After the plunger 2 finishes the suction stroke, the plunger 2 turns into an upward motion and moves to an upward stroke. Here, the coil 43 remains in a non-energized state, and the magnetic biasing force does not act. The rod biasing spring 40 is set to bias the flange portion 35a (rod protrusion portion) protruding to the outer diameter side of the rod 35 and have a biasing force necessary and sufficient to keep the suction valve 30 opening in the non-energized state. The volume of the pressurizing chamber 11 decreases with the upward motion of the plunger 2, but in this state, the fuel having been once sucked into the pressurizing chamber 11 is returned to the suction passage 10d through the opening portion 31c of the suction valve 30 in the valve opening state again, and hence the pressure in the pressurizing chamber does not increase. This stroke is referred to as a return stroke.

In this state, when a control signal from the ECU 27 is applied to the electromagnetic valve mechanism 300, a current flows through the coil 43 through the terminal 46. A magnetic attraction force acts between the fixed core 39 and the anchor 36, and the fixed core 39 and the anchor 36 impinge with each other on a magnetic attraction surface S. The magnetic attraction force overcomes the biasing force of the rod biasing spring 40 to bias the anchor 36, and the anchor 36 engages with the flange portion 35a to move the rod 35 in a direction away from the suction valve 30.

At this time, the suction valve 30 is closed by the biasing force of a suction valve biasing spring 33 and the fluid force caused by the fuel flowing into the suction passage 10d. After the valve is closed, the fuel pressure in the pressurizing chamber 11 increases with the upward motion of the plunger 2, and when the fuel pressure becomes equal to or higher than the pressure at the fuel discharge port 12, the high-pressure fuel is discharged via the discharge valve mechanism 8 and supplied to the common rail 23. This stroke is referred to as a discharge stroke.

That is, the upward stroke from the lower start point to the upper start point of the plunger 2 includes a return stroke and a discharge stroke. Then, an amount of the high-pressure fuel to be discharged can be controlled by controlling the timing of energizing the coil 43 of the electromagnetic valve mechanism 300. If the timing of energizing the coil 43 is made earlier, the ratio of the return stroke in the compression stroke is small and the ratio of the discharge stroke is large. That is, less fuel is returned to the suction passage 10d and more fuel is discharged at high pressure. On the other hand, if the energization timing is delayed, the ratio of the return stroke is large and the ratio of the discharge stroke is small in the compression stroke. That is, more fuel is returned to the suction passage 10d, and less fuel is discharged at high pressure. The timing of energizing the coil 43 is controlled by a command from the ECU 27.

By controlling the timing of energizing the coil 43 as described above, the amount of fuel discharged at high pressure can be controlled to an amount required by the internal combustion engine.

Next, a characteristic configuration of the high-pressure fuel pump according to the present embodiment will be described with reference to FIG. 5. The fixed core 39 is precipitation hardening type ferritic stainless steel (ferritic precipitation hardening type metal). The anchor 36 is precipitation hardening type ferritic stainless steel attracted by the magnetic attraction force of the fixed core 39. This can ensure wear resistance and magnetic properties.

The outer core 38 has an inner peripheral surface on which the outer peripheral surface of the anchor 36 slides. The seal ring 48 is formed of a material having hardness lower than that of the fixed core 39 and the anchor 36, and connects the fixed core 39 and the outer core 38. It can be paraphrased that the seal ring 48 is formed of a material (e.g., austenitic stainless steel) having hardness lower than that of the ferritic precipitation hardening type metal. This can mitigate the impact load as described later.

Subsequently, impingement of the fixed core 39 and the anchor 36 on the magnetic attraction surface S will be described in detail. Immediately after the anchor 36 impinges on the fixed core 39, impingement stress is generated in the vicinity of the contact portion. By the seal ring 48 elastically deforming during the generation period of the impingement stress, the fixed core 39, the first yoke 42, the second yoke 44, and the fixing pin 832 move in the direction receiving impact force (leftward in FIG. 5), and the impact load generated in the fixed core 39 and the anchor 36 is mitigated.

The material of the fixed core 39 and the anchor 36 is precipitation hardening type ferritic stainless steel, which has magnetic properties similar to that of ferritic stainless steel, but also has hardness similar to that of the precipitation hardening type stainless steel (HV 300 or higher depending on the manufacturing method). Therefore, it can withstand a certain level of stress. Furthermore, the impingement stress can be reduced by the mitigation effect described above, and the durability of the impingement surface can be ensured.

It is important for the seal ring 48 to be thin and capable of large-scale deformation (=elongation is large). Here, the seal ring 48 has an elongation larger than that of the fixed core 39 and the anchor 36.

The seal ring 48 has an elongation rate of, for example, 35% or more. In addition, the seal ring 48 is required to be non-magnetic (non-magnetic body) in terms of magnetic performance, and specifically, is desirably formed of austenitic stainless steel. In general, the austenitic stainless steel is non-magnetic and has an elongation rate of 35 to 45% or more.

The seal ring 48 has a cylindrical shape. The fixed core 39 and the outer core 38 have insertion portions 39ins and 38ins, respectively, to be inserted into the seal ring 48. The fixed core 39 and the outer core 38 have an outer peripheral surface flush with an outer peripheral surface CS of the seal ring 48 in a state of being inserted into the seal ring 48. This facilitates attaching of other components such as the bobbin 45, for example.

Precipitation hardening type ferritic stainless steel is specifically composed of the following composition. Cr: 13 to 15%, Ni: about 3%, Cu: 2% or less, C: 0.05% or less, S: 0.05% or less, and Mo: 4% or less. By subjecting this metal to solution treatment and aging treatment, it becomes possible to obtain the hardness close to 370 HV. In general, the precipitation hardening type stainless steel has a small elongation (5% or less), but the precipitation hardening type of ferrite having good magnetic properties has a further smaller elongation (about 1%). In order to make up for this low elongation, the seal ring 48 is formed thin and mitigates the impingement load by deforming.

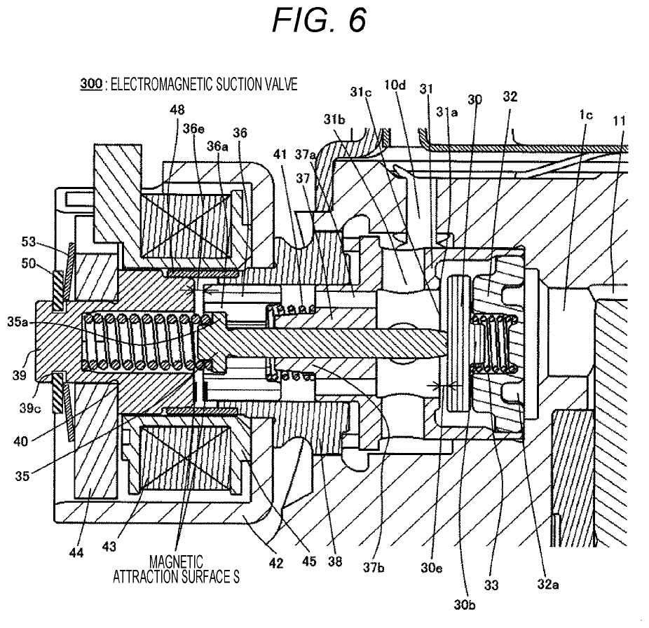

FIG. 6 illustrates another embodiment. In the present embodiment, a cylindrical groove 39c is formed in the fixed core 39, and an annular member 50 is inserted or press-fitted thereinto. An elastic material 53 is provided between the annular member 50 and the second yoke 44 to absorb backlash due to a gap generated between the annular member 50 and the second yoke 44 and to apply an axial biasing force. With this configuration, the annular member 50 can generate a fixing force larger than that of the fixing pin 832 depending on the depth design of the groove 39c. As a result, the fixing force of the fixed core 39 and the second yoke 44 can be strengthened, thereby allowing them to follow even larger impingement vibration without separation.

As described above, according to the present embodiment, it is possible to provide an electromagnetic valve which achieves both mover reliability and manufacturing cost without deteriorating magnetic properties, and a high-pressure fuel pump equipped with the electromagnetic valve.

In particular, use of a ferritic precipitation hardening type metal for the fixed core 39 and the anchor 36 allows good magnetic properties to be ensured. In addition, use of the seal ring 48 formed of a material having hardness lower than that of the ferritic precipitation hardening type metal allows reliability for cracking to be ensured.

The present invention is not limited to the above-described embodiments, and includes various modifications. For example, the embodiments described above have been described in detail for an easy-to-understand explanation of the present invention, and are not necessarily limited to those having all the described configurations. It is also possible to replace part of the configuration of one embodiment with the configuration of another embodiment, and it is also possible to add the configuration of another embodiment to the configuration of one embodiment. It is further possible to add, delete, or replace other configurations for part of the configuration of each embodiment.

In the above embodiment, as an example, the seal ring 48 is formed of austenitic stainless steel, but is not limited thereto and may not be formed of a metal.

The embodiment of the present invention may have the following aspects.

(1). A high-pressure fuel pump, including an electromagnetic suction valve having a precipitation hardening type metal magnetic core and a seal ring arranged radially outside the magnetic core, the seal ring to which the magnetic core is fixed, in which the seal ring is formed of a metal having hardness lower than that of the magnetic core.

(2). The high-pressure fuel pump according to (1), in which the magnetic core is welded and fixed to the seal ring.

(3). The high-pressure fuel pump according to (2), in which the seal ring is arranged between the magnetic core and a fixed core in a valve body axial direction, and is welded and fixed to the fixed core.

(4). The high-pressure fuel pump according to (1), in which the magnetic core is formed of SUS630 (17Cr-4Ni-4CU-Nb).

In other words, the high-pressure fuel pump includes an electromagnetic suction valve having a precipitation hardening type metal magnetic core and a thin seal ring arranged radially outside the magnetic core, the seal ring to which the magnetic core is fixed, in which the seal ring is formed of a metal having an elongation larger than that of the magnetic core.

Furthermore, the electromagnetic suction valve includes an anchor that drives the valve body, and is configured such that the anchor impinges on the magnetic core by energizing the solenoid.

Furthermore, the electromagnetic suction valve is configured such that the magnetic core is welded and fixed to the seal ring. Yet furthermore, in the electromagnetic suction valve, the seal ring is arranged between the magnetic core and the fixed core in the valve body axial direction, and is welded and fixed to the fixed core.

This reduces the impingement force by elongation of the thin seal ring holding the magnetic core when the anchor impinges on the magnetic core. Furthermore, until the effect of reducing the impingement force is exerted, it is possible to withstand the impingement stress due to the material properties of the high-hardness magnetic core.

By using the malleability of the seal ring in the elastic axial direction, it is possible to (A) “absorb and mitigate impact at the time of impingement of the anchor” and (B) “prevent a welded portion from breaking due to stress concentration in a non-magnetic material fixed portion (welded portion) caused by thermal stress”.

### REFERENCE SIGNS LIST

1 pump body
1a flange
1b hole
1c hole
2 plunger
4 spring
6 cylinder
6a fixed portion
7 seal holder
7a auxiliary chamber
8 discharge valve mechanism
8a discharge valve seat
8b discharge valve
8c discharge valve spring
8d discharge valve stopper
8e abutting portion
9 pressure pulsation reduction mechanism
9a holding member
10a low-pressure fuel suction port
10b, 10c damper chambers
10d suction passage
11 pressurizing chamber
12 fuel discharge port
12a discharge valve chamber
12b fuel discharge passage
13 plunger seal
14 damper cover
15 retainer
20 fuel tank
21 feed pump
23 common rail
24 injector
26 pressure sensor
27 engine control unit
28 suction pipe
30 suction valve
30e movement amount
31 suction valve seat member
31a suction valve seat
31b suction port
31c opening portion
32 stopper
33 suction valve biasing spring
35 rod
35a flange portion
36 anchor
36a through-hole
36e movement amount
37 rod guide
37a through-hole
37b center bearing portion
38 outer core
39 fixed core
39c groove
40 rod biasing spring
42 first yoke
43 coil
44 second yoke
45 bobbin
46 terminal
47 connector
48 seal ring
50 annular member
51 suction joint
52 suction filter
53 elastic material
61 O-ring
90 high-pressure fuel pump mounting portion
92 tappet
93 cam
200 relief valve mechanism
201 relief body
202 relief valve
203 relief valve holder
205 stopper
300 electromagnetic valve mechanism
832 fixing pin

1. A high-pressure fuel pump, comprising:
a ferritic precipitation hardening type metal fixed core;
a ferritic precipitation hardening type metal anchor attracted by a magnetic attraction force of the fixed core;
an outer core having an inner peripheral surface on which an outer peripheral surface of the anchor slides; and
a seal ring formed of a material having hardness lower than hardness of the fixed core and the anchor, the seal ring connecting the fixed core and the outer core.

2. The high-pressure fuel pump according to claim 1, wherein:
the seal ring has an elongation larger than an elongation of the fixed core and the anchor.

3. The high-pressure fuel pump according to claim 1, wherein:
the seal ring has an elongation rate of 35% or more.

4. The high-pressure fuel pump according to claim 1, wherein:
the seal ring is a non-magnetic body.

5. The high-pressure fuel pump according to claim 1, wherein:
the seal ring has a cylindrical shape,
the fixed core and the outer core each have an insertion portion to be inserted into the seal ring, and
the fixed core and the outer core have an outer peripheral surface flush with an outer peripheral surface of the seal ring in a state of being inserted into the seal ring.

6. The high-pressure fuel pump according to claim 1, wherein:
the ferritic precipitation hardening type metal is ferritic precipitation hardening type stainless steel.
